(19) United States
(12) Patent Application Publication
(10) Pub. No.: US 2014/0238878 A1
(43) Pub. Date: Aug. 28, 2014

(54) Keepsake digital media capsule and display holder

(71) Applicant: GERARD STEPHEN HENWOOD, BEREA, OH (US)

(72) Inventor: GERARD STEPHEN HENWOOD, BEREA, OH (US)

(21) Appl. No.: 13/815,361

(22) Filed: Feb. 25, 2013

(51) Int. Cl. G11B 33/02

(52) U.S. Cl. CPC G11B 33/025
USPC 206/308.3

(57) ABSTRACT

One embodiment of a durably made cylindrical or round capsule (24) housing a flash drive (8) or similar digital media retained by a threaded capsule body (10) and capsule closure (12) for ready removal or return of media. In addition, a capsule holder (26) housing a single or plurality of capsules is provided for further protection and keepsake presentation. The capsule holder comprises a base (30) and cover (32). Both capsule (24) and capsule holder (26) have means identification (22) and (40). Other embodiments are described and shown.

### BACKGROUND OF THE INVENTION

This invention relates to durable storage of digital memory, specifically that of a memory stick flash drive or similar size digital medium, and its keepsake presentation.

### DESCRIPTION OF THE PRIOR ART

The following is a tabulation of some prior art that presently appears to be relevant:

### U.S. PATENTS

| Patent Number | Kind Code | Issue Date | Patentee |
|---|---|---|---|
| 4,665,668 | B1 | May 19, 1987 | Serpico |
| 3,864,755 | B1 | Feb. 4, 1975 | Hargis |
| 7,934,298 | B1 | May 3, 2011 | Ghazvini |

### U.S. PATENT APPLICATION PUBLICATIONS

| Publication Nr. | Kind Code | Publication Date | Applicant |
|---|---|---|---|
| US 2008/0156676 A1 | A1 | Jul. 3, 2008 | Verma |
| US2010/0264047 A1 | A1 | Oct. 21, 2010 | Kelley et al. |

Photo albums, scrapbooks, yearbooks, wedding albums and family histories are keepsakes that people assemble to preserve the knowledge and memories of lifetimes. They are made in a book or binder construction format. With the common use of digital and cloud stored photo albums viewed on screens on desktop, laptop, pad or digital picture frame computers items that were once only available in a book or binder format are available using every day digital technology. Use of compact discs (CDs) as digital photo albums of a special event, such as a wedding, is becoming a popular way to dedicate a booklet sized case containing a CD to a very special lifetime event. The size of the CD case is much more compact than a typical wedding album, but, it is such that it is big enough at 5″×5″ minimum to place a captioned photo or card with a title of the CD on its front cover. U.S. Pat. No. 3,864,755 (1975) to Hargis is typical of a host of CD cases invented. While compact discs and their cases are easy to use and of a size that lends them to be adorned with an exterior title sheet and/or image, they do not lend themselves to being shatterproof, waterproof and heat resistant as compared to a digital memory stick flash drive. Safe storage of a keepsake CD usually means putting it in a strong box or safe. The flash drive, being small and stick shaped more readily lends itself to being placed in a container that will resist damage from a house fire or natural disaster.

Memory sticks present a geometry that allows them to be stored in a capsule just slightly larger than the stick itself, that, if made in a generally tubular fashion, will allow for a threaded closure and superior structural strength compared to a CD. While this compactness and durability can be an advantage to storing consumer-related digital media, it also presents the limiting effect of being small, difficult to find and not presented as a special album or book size format. Patent application by Kelley et al. US 2010/0264047 (2010) shows a pocket watch type flash drive holder that moves in the direction of a flash drive containing digitized keepsake material. While being attractive and portable it is more prone to damage than a capsule. Ghizvini U.S. Pat. No. 7,934,298 (2011) also offers a digital life story component in his case that includes a sealed compartment for a deceased person or animal's ashes. The geometry being rectangular does not provide the advantage of the inherent strength of a cylindrical capsule for the digital information storage.

Time capsules, of the type to be buried such as U.S. Pat. No. 4,665,668 (1987) to Serpico, while providing a durable means of storing items relevant to a person or group of people are fairly expensive in that they must be built of materials and designs that will survive the effects of water intrusion and collapse. Time capsules, are also restricted access containers, generally meant only to be opened at a single future date. A binder for storing a plurality of memory sticks and SD cards as offered by Verma US Patent Application US 2008/01566676 offers a over time and does not present a flash single drive's contents as special, but as one of a group.

### SUMMARY

In accordance with one embodiment a capsule comprises nearly indestructible yet quick-opening cylinder and closure for safe home storage of flash drive or similar sized digital media. In accordance with a second embodiment the capsule is housed in a container giving it greater visibility and which gives the impression that the container's contents are special to the person(s) who stored images and/or audio on the flash drive contained therein.

### ADVANTAGES

Accordingly, several advantages of one or more aspects are as follows: to provide a protective container for a flash drive or similar-sized digital storage media whose contents are what would be traditionally kept in a bound scrapbook, wedding album, or photo album, giving the contents a digital embodiment that is very likely to last for hundreds or thousands of years. To provide a housing for the capsule that presents the capsule as a special keepsake and provides room for an identifying nameplate and other adornments that enhance the presentation of the capsule and capsule housing. To provide a substantial impact and water proof and heat resistant digital media storage that would be substantially less costly and easier to manufacture than a similar container for a compact disc, to provide people with a way to leave a life story legacy to future generations, to provide a capsule presentation when its contents are being shown on a viewing screen, that says the images being seen are very special to the person(s) who assembled the digital media and went to the effort of placing it is a special capsule and capsule holder. Other advantages of one or more aspects will be apparent from a consideration of the drawings and the ensuing description.

### DRAWINGS—FIGURES

FIG. 1 shows a capsule for holding a flash drive or similar digital storage media closed

FIG. 2 shows a capsule for holding a flash drive or similar digital storage media opened

FIG. 3 shows a container housing a capsule for a flash drive or similar digital storage media.

FIG. 4 shows a container housing a capsule for a flash drive or similar digital storage media with the cover removed

FIG. 5 shows the container holding the capsule for a flash drive or similar digital media on display set upon the container lid.

### DRAWINGS—REFERENCE NUMBERS

| | | | |
|---|---|---|---|
| 8 | flash drive | 10 | capsule body |
| 12 | capsule closure | 14 | capsule chamber |
| 16 | opening of capsule | 18 | capsule chamber threads |
| 20 | capsule closure threads | 22 | capsule identification |
| 24 | capsule | 26 | capsule holder |
| 30 | capsule holder base | 32 | capsule holder cover |
| 34 | capsule holder locator | 36 | capsule holder base side |
| 38 | capsule holder base bottom | 40 | capsule holder identification |

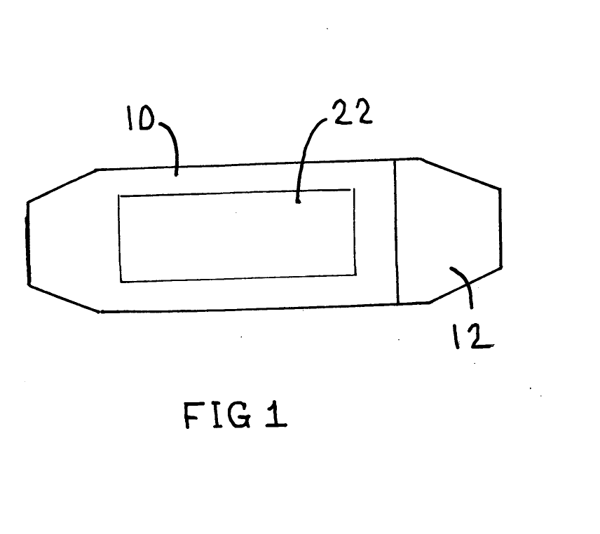

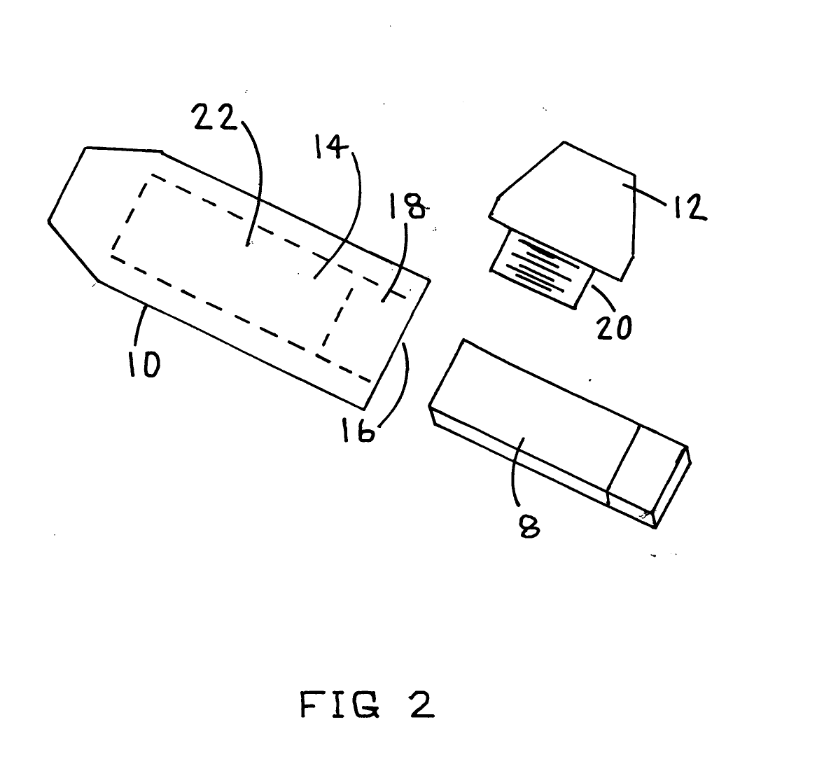

### DETAILED DESCRIPTION—FIGS. 1 AND 2—FIRST EMBODIMENT

The first embodiment of the invention is illustrated in FIG. 1 (top view of closed capsule) and FIG. 2 (exploded view of opened capsule). The metal capsule body 10 has a chamber 14 for holding a flash drive 8 or similar-sized digital media and a closure 12 which in this embodiment is threaded 20 to connect to the capsule chamber threads 18. The treaded closure 12 and the surface where the closure meets the metal capsule body in this embodiment prevent the ingress of water as could happen in the event of a house fire from fire fighter's hoses. The preferred embodiment is to have engraved identification of the capsule flash drive contents on the exterior surface of the capsule body 22. An alternative embodiment would be to have an identification tag attached to the capsule chamber with rivets or adhesive.

### Operation—FIG. 2

A flash drive 8 or similar sized digital media is inserted into the capsule chamber 14 at the opening 16 for safe keeping. In this embodiment the chamber 14 is then secured by means of a threaded closure 12 and stored wherever one would place a keepsake item, in a drawer, a safe, or displayed. The capsule allows for ready access of the flash drive by turning the closure 12 out of the capsule body 10. The flash drive is inserted into a computer, digital picture (frame) display for viewing and listening if audio material is stored on it.

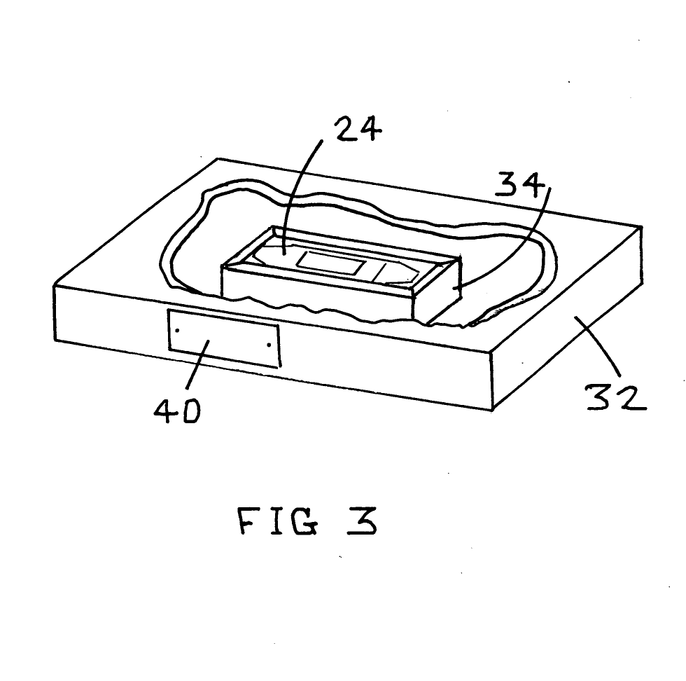

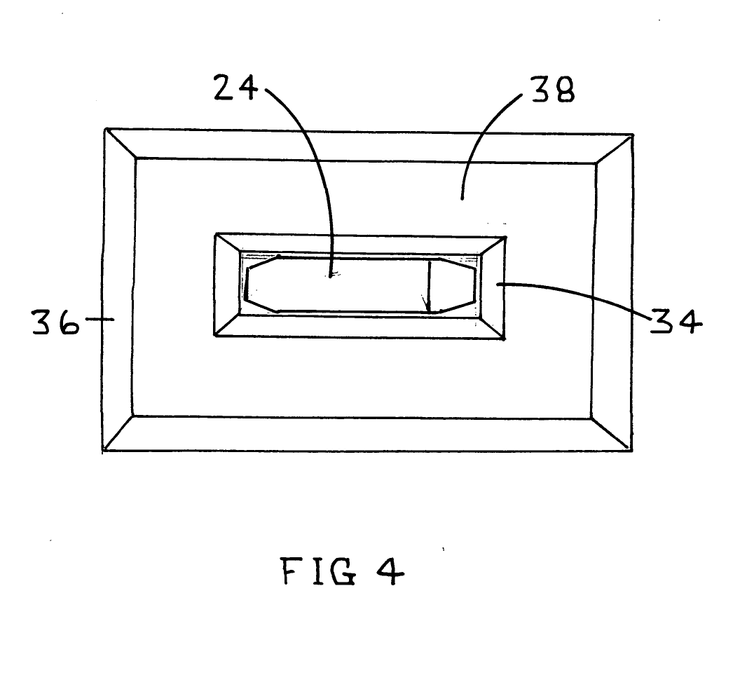

### DETAILED DESCRIPTION—FIGS. 3 AND 4—SECOND EMBODIMENT

The second embodiment of this invention is illustrated in FIG. 3 (perspective view of the capsule holder with a cut-away) and FIG. 4 (top view of holder base). The capsule 24 described in the first embodiment is placed in the holder 26 as a keepsake. The holder is typically made of wood and is the size of a book. This size makes the holder large enough to be easily found and noticeable on a bookshelf. The capsule holder 26 has a base 30 that in the preferred embodiment has a flat bottom 38, sides 36, and an open box component surrounding the capsule known as the capsule holder locator 34 for centering the capsule 24 in the capsule holder 26. The holder cover 32 can be attached by hinge, grooved tracks or other means to the capsule holder base 30. The embodiment shown has a simple five sided cover (lid) 32 that is installed over the face and sides of the capsule holder base 30.

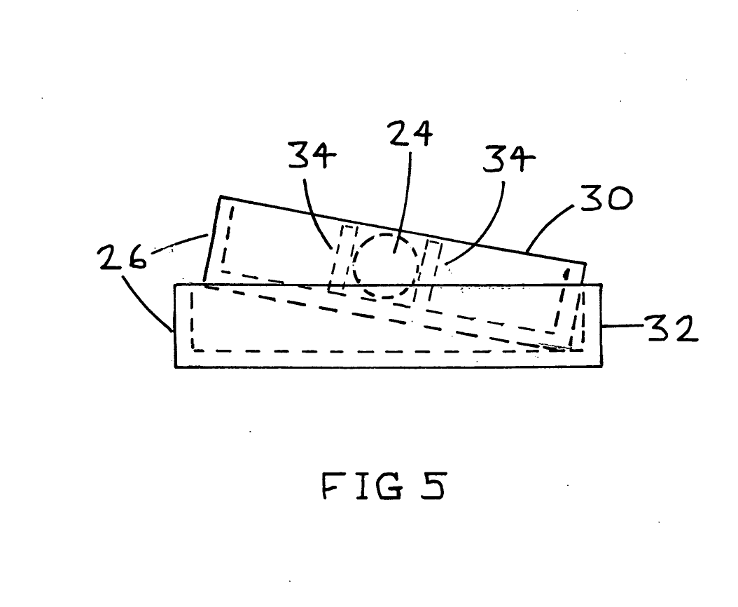

### Operation—FIG. 5

The capsule holder cover or lid 32 is opened or removed and the capsule 24 is placed in the capsule holder base 30 within the capsule holder locator 34. The cover 32 is then closed or placed back on the capsule holder base 30. The capsule holder cover 32 is then removed (opened) to remove the capsule 24 holding the flash drive 8 or similar sized digital storage media. The base 30 can be used for displaying the capsule 24. Displaying the capsule 24 can be done when the flash drive 8 is being used to run its digital contents. In the embodiment shown the cover 32 is a separate part that the base 30 can be set into for tilted up display of the capsule 24.

### Conclusion, Ramifications, and Scope

Accordingly the reader will see that, according to one embodiment of the invention, I have provided a capsule capable of protecting small size precious digital content from various types of damage. The capsule is robust. Being a machined (or cast) and engraved metal offers a presentation of long lasting respectfulness for the event(s) portrayed in the digital content.

According to the second embodiment the capsule is provided a dignified and easily located holder dignity in a manner similar to a memorial marker. The combination of the metallic capsule and a wooden holder lined with a premium fabric such as velvet.

Furthermore the compact digital capsule and book-size holder offers additional advantages in that:
Unlike a time capsule which is buried or not to be opened for a number of years the objects of this invention are accessible for anniversary or anytime viewing.
Unlike a CD case which also provide a small booklet-like size format the generally cylindrical shape of the flash drive size capsule is far easier to water proof and protect from impact damage such as could occur during a house fire or natural disaster.
The appearance of the capsule and the holding case show the contents are important to the person(s) who assembled the digital content.
The capsule and holding case can be used for baby's first years, as a high school or college yearbook, a wedding album, a special time or event, a life story or any other purpose a user defines.
Preserving the special content for future generations offers a person is a treasure trove of family history and genealogical information. The capsule takes full advantage of the fact that never before could so much personal content be securely stored in such a small place. Although the description above contains many specificities, these should not be construed as limiting the scope of the embodiments but merely providing illustrations of some of the several embodiments. For example, the capsule and holder can have numerous other shapes. The capsule can be made from square or hexagonal metal bar stock of any of many types of metal, stone, plastic, wood or any solid material. The holder can be of any size or shape. It could appear book-like with a book binding. It could be a sculpture or other object with a storage port for the capsule. The only limit for the designs of the capsule and capsule holder are the human imagination.

Thus the scope of the embodiments should be determined by the appended claims and their legal equivalents, rather than by the examples given.

What is claimed is:

1. A durable capsule with a cylindrical or round chamber for protecting and storing a removably retained flash drive or similar sized digital media at home or a safe accessible place.

2. A capsule of claim 1 with a permanent means of identification engraved (or etched) on said capsule or engraved on a plate (tag) which is attached to said capsule by rivets, adhesive, or any other means.

3. A container housing a capsule with a cylindrical or round chamber for protecting and storing a removably retained flash drive or similar sized digital media at home or a safe accessible place.

4. A container of claim 3 with a permanent means of identification engraved (or etched) on said container or engraved on a plate (tag) which is attached to said capsule by rivets, adhesive, or any other means.

5. A capsule of claims 1 and 2 combined with a container of claims 3 and 4.

6. A container of claim 3 that houses a plurality of capsules.
